(19) United States
(12) Patent Application Publication
(10) Pub. No.: US 2024/0359774 A1
(43) Pub. Date: Oct. 31, 2024

(54) ELECTRIC SCOOTER PROVIDED WITH A GEARBOX

(71) Applicant: M.T. DISTRIBUTION S.R.L., Calderara Di Reno (BO) (IT)

(72) Inventors: Andrea Raffaelli, Calderara Di Reno (BO) (IT); Alessandro Sorio, Calderara Di Reno (BO) (IT); Alessandro Summa, Calderara Di Reno (BO) (IT)

(21) Appl. No.: 18/309,511

(22) Filed: Apr. 28, 2023

(51) Int. Cl. B62M 9/06; B62K 11/06; B62K 11/14; B62M 7/06

(52) U.S. Cl. CPC B62M 9/06; B62K 11/06; B62K 11/14; B62M 7/06

(57) ABSTRACT

Electric scooter having: a footboard; at least one driving wheel that is coupled to the footboard and is arranged in a front or rear position; at least one driven wheel which is coupled to the footboard and is arranged in a rear or front position; a handlebar operatively coupled to the footboard to turn a front wheel; an electric motor that is suitable for turning the driving wheel; and a gearbox with two or more gear ratios that is interposed between the electric motor and the driving wheel to receive the motion from the electric motor and transmit motion to the driving wheel.

### TECHNICAL FIELD

The present invention refers to the field of last mile transportation and in particular it relates to an electric scooter provided with a gearbox.

### PRIOR ART

The scooter is a vehicle with two or more wheels, whose movement is determined by human muscular propulsion by means of the lower limbs. It consists of a footboard, on which the feet rest and where the wheels are pivoted, a handlebar operatively connected to at least one wheel and the footboard to allow the change of direction, and a brake, usually placed at the back to slow down the rear wheel and, therefore, consequently the scooter. According to some regulations, comprising Italian legislation, the scooter can also be provided with a pair of independent brake controls on two axes.

Numerous alternatives are also known, for example in the structure and dimension of the footboard and handlebar, namely, relative to the type of brakes used, of the type arranged at the hand grip on the handlebar. In the evolution of propulsion, mechanical scooters have been developed, in which traditional scooters are provided with mechanical devices to optimize thrust, for example by means of oscillating pedals operatively connected to the rotation axis of at least one of the wheels.

The mechanical scooter has seen its evolution into the electric scooter that is currently available in many versions, being used above all in last mile transportation or micro-mobility, namely, the last leg movement of people and goods with notable diffusion especially in cities.

Electric scooters are scooters in which the propulsion is achieved, exclusively or mainly, by an electric motor powered by a battery with which the electric scooters are provided. The success thereof has been determined by the development of electric motors light enough to be mounted on a traditional scooter, and more efficient batteries.

The most commonly used electric scooters generally have two small hard wheels, with a folding frame, usually made of aluminium, but even in this case numerous alternatives are also known.

One of the major problems in the use of electric scooters is related to the poor adaptability to the route to be covered.

In particular, the use of the electric motor can provide for different power levels according to the speed needs of the user or the difficulty of the electric scooter in moving on paths with a high inclination. Therefore, in cases in which the power level used is high, the capabilities of covering long distances are consequently limited due to the premature depletion of the battery.

It would therefore be desirable to have an electric scooter capable of minimizing the drawbacks described above. In particular, it would be desirable to have an electric scooter able to guarantee high adaptability to the route to be covered and, at the same time, optimal flexibility while maintaining a high autonomy (generally measured as the maximum distance that can be travelled starting from a fully charged battery condition).

### DESCRIPTION OF THE INVENTION

The object of the present invention is to provide an electric scooter provided with a gearbox which has a reduced production and maintenance cost and is also able to guarantee a wide flexibility of use and a high autonomy.

According to the present invention an electric scooter with powered gearbox is provided, according to what is claimed in the attached claims.

The claims describe preferred embodiments of the present invention forming an integral part of the present description.

### BRIEF DESCRIPTION OF THE DRAWINGS

The present invention will now be described with reference to the attached drawings, which illustrate some non-limiting embodiments thereof, wherein:

FIG. 1 is a front perspective view and partially in section of an electric scooter;

FIGS. 2 and 3 are two different rear perspective views and partially in section of an alternative embodiment of an electric scooter;

FIG. 4 is a rear perspective view and partially in section of a further embodiment of an electric scooter;

FIG. 5 is a front perspective view of another embodiment of an electric scooter;

FIG. 6 is a perspective view and on an enlarged scale of a rear area of the electric scooter of FIG. 5; and

FIGS. 7-11 are perspective views of as many alternatives of the rear area of the electric scooter of FIG. 5.

### PREFERRED EMBODIMENTS OF THE INVENTION

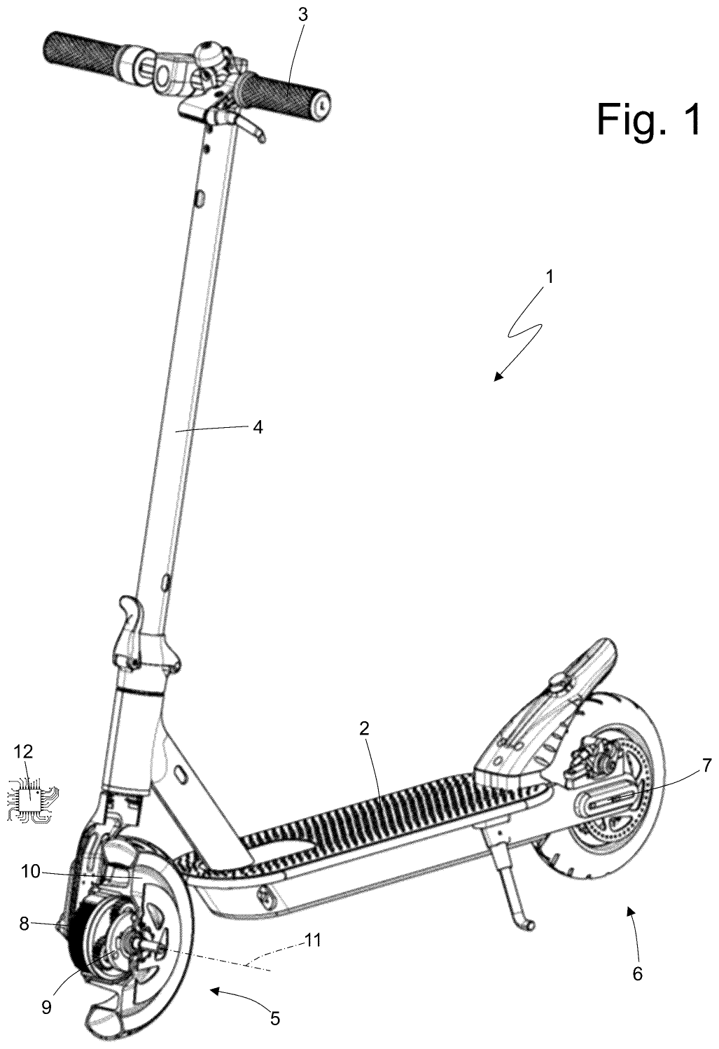

In FIG. 1, the reference number 1 denotes as a whole an electric scooter 1 in a first preferred embodiment and according to a front perspective view.

The electric scooter 1 comprises a footboard 2 having a substantially parallelepiped shape and designed to fit one or both feet of a user and a handlebar 3 that is operatively coupled to the footboard 2; namely, the footboard 2 is a structure intended as resting place or support for both feet of the user. In particular, the handlebar 3 is coupled to the footboard 2 by means of an elongated support 4, having a cylindrical shape, which can be extended and folded onto the footboard 2 when not in use. According to further embodiments not illustrated, the footboard 2, the handlebar 3 and the support 4 can be made with different shapes and for example the support 4 could be of the non-extendable and/or non-foldable (fixed) type.

The electric scooter 1 comprises a pair of wheels 5 and 6 (front wheel 5 and rear wheel 6), arranged aligned with respect to the direction of motion of the electric scooter 1 when in use. By way of example, the wheels 5 and 6 have a diameter of 10 inches but could have different dimensions according to the technical requirements of the electric scooter 1.

In particular, a front wheel 5 is coupled to the footboard 2 at the front relative to the direction of motion, whereas a rear wheel 6 is coupled to the footboard 2 at the back relative to the direction of motion. According to a preferred (but not binding) embodiment, the rear wheel 6 is attached to the footboard 2 by means of a swingarm 7 which allows the same to rotate around a respective rotation axis; in the embodiment illustrated in the attached FIGS. 1, the swingarm 7 is single-sided whereas according to other embodiments not illustrated, the swingarm 7 is double-sided (and therefore is “U”-shaped). Namely, the swingarm 7 at one end supports the rear wheel 6 and at the opposite end it is hinged to the footboard 2 at a fulcrum. The front wheel 5 is attached to the footboard 2 by means of the elongated support 4; in this way, the handlebar 3 (integral with the elongated support 4) allows the front wheel 5 to rotate with respect to the footboard 2.

The propulsion of the electric scooter 1 is achieved by exclusive or assisted means of an electric motor 8 with which the electric scooter 1 is provided. Typically, the user must start the electric scooter 1 by means of human propulsion, creating the first movement which determines the start of the electric motor 8, since, without the initial movement caused by the user the electric scooter 1 does not move for safety reasons even when acting on the accelerator. In the embodiment illustrated in the attached figures, the electric motor 8 is coupled to the rear wheel 6 and therefore drives the rear wheel 6; according to a different embodiment not illustrated, the electric motor 8 is coupled to the front wheel 5 and therefore drives the front wheel 5. In particular, the electric motor 8 is arranged outside the rear driving wheel 6, namely, the electric motor 8 is not coaxial with the rear driving wheel 6 and is arranged at a given distance from the rear driving wheel 6.

The movement capacity is also ensured by one or more battery packs electrically coupled to the electric motor 8. The battery pack, not illustrated, is preferably housed inside the footboard 2 to lower the centre of gravity of the electric scooter 1 but could also be arranged in a different position (for example along the support 4).

In order to allow the electric scooter 1 to ensure high adaptability to the route to be covered, the electric motor 8 is coupled to a gearbox 9 with which the electric scooter 1 is provided; in other words, the gearbox 9 with two or more gear ratios is interposed between the electric motor 8 and the front driving wheel 5 to receive motion from the electric motor 8 and transmit motion to the front driving wheel 5. In the embodiment illustrated in the attached figures, the gearbox 9 has three different gear ratios, but according to further embodiments not illustrated, the gearbox 9 could have a different number of gear ratios (for example only two or four, five or more). Furthermore, the gearbox 9 could be continuously variable and therefore could have a theoretically infinite number of gear ratios.

As illustrated in FIG. 1, the front wheel 5 is a driving wheel and is provided with a wheel rim 10 that defines an enclosed container in which both the electric motor 8 and the gearbox 9 are housed. In particular, the coupling between the electric motor 8 and the gearbox 9 is achieved axially, namely, by arranging the electric motor 8 and the gearbox 9 side by side within the wheel rim 10 sharing the same rotation axis 11. In other words, the front driving wheel 5 (namely, the wheel rim 10 of the front wheel 5), the gearbox 9 and the electric motor 8 are all coaxial with respect to the same rotation axis 11 of the front wheel 5. In particular, a shaft of the electric motor 8 is directly (namely, without any interposed element) connected to an input of the gearbox 9, and an output of the gearbox 9 is directly (namely, without any interposed element) connected to the front driving wheel 5. This arrangement allows the size and weight of the electric scooter 1 to be considerably reduced despite the presence of the gearbox 9. Furthermore, the presence of the enclosed container 10 obtained directly in the wheel rim allows all the components necessary for traction and management thereof to be housed within the driving wheel.

The gearbox 9 illustrated in FIG. 1 is epicyclic and allows, with a thickness of about 30 mm, to considerably reduce the dimensions of the enclosed container of the wheel rim 10, resulting substantially only slightly wider than a container of the wheel rim 10 designed to contain only the electric motor 8 and therefore with reduced weight and costs.

In this regard, the electric scooter 1 illustrated in FIG. 1 is provided with a disc brake for slowing down and stopping, which needs to be spaced from the wheel rim 10 in order to be able to house the brake caliper with respect to a traditional electric scooter, therefore devoid of a gearbox. In the embodiment not illustrated in which the electric scooter 1 is, on the other hand, provided with a drum brake, the size of the wheel rim 10 is considerably larger due to the same larger size of the drum brake.

The use of the gearbox 9 allows the electric motor 8 not only to provide different power levels according to the speed needs of the user but to modify the torque value to the front driving wheel 5 according to the route difficulty of the electric scoter 1, for example when moving uphill. Therefore, while using reduced power levels, it is possible to increase the torque to the front driving wheel 5 (by inserting a shorter gear ratio in the gearbox 9), thus considerably reducing the energy required by the electric motor 8 as well as the depletion of the battery.

In consideration of the possibility of managing the gearbox 9 also in automatic mode (power-assisted), the gearbox 9 could be power-assisted (namely, provide for an electric actuator configured to vary the gear ratio) and therefore comprise a control device 12 (schematically illustrated in FIG. 1 and provided with a microcontroller) designed for automatically select the gear ratio according to one or more predefined parameters. The control device 12 is typically coupled directly to the mechanical part and therefore arranged within the same enclosed container as the wheel rim 10 but could equally be arranged in an external position and spaced from the mechanical part.

The control device 12 is designed to place the gearbox 9 in the shortest gear ratio at the start and to automatically select the gear ratio according to one or more predefined parameters.

Taking into account the current absorption by the electric motor 8, the gearbox 9 can therefore allow starting off in the shortest gear ratio, namely, in the lowest gear, and subsequently the gearbox 9 automatically selects a longer gear ratio, higher gear, when the electric motor 8 absorbs a given amount of electric current, for example a value greater than 12-15 Ampere.

The predefined parameters taken into consideration by the control device 12 to establish the gear ratio to be used can comprise, for example, one or more of the following parameters: a number of revolutions of the electric motor 8, a value of the torque delivered by the electric motor 8, a value of the electric current drawn by the electric motor 8, positioning coordinates of the electric scooter 1 (provided by a satellite positioning system), values provided by an inertial platform (namely, an progressive sensor which measures the position of the electric scooter 1 in space and the accelerations-decelerations to which the electric scooter 1 is subjected). Further parameters for managing the shifting can be a pressure value of the clutch actuators, a sliding between the two parts of the incoming clutch, namely, quantities derived from the previous ones, comprising torques on the clutches or an acceleration profile of the electric scooter 1.

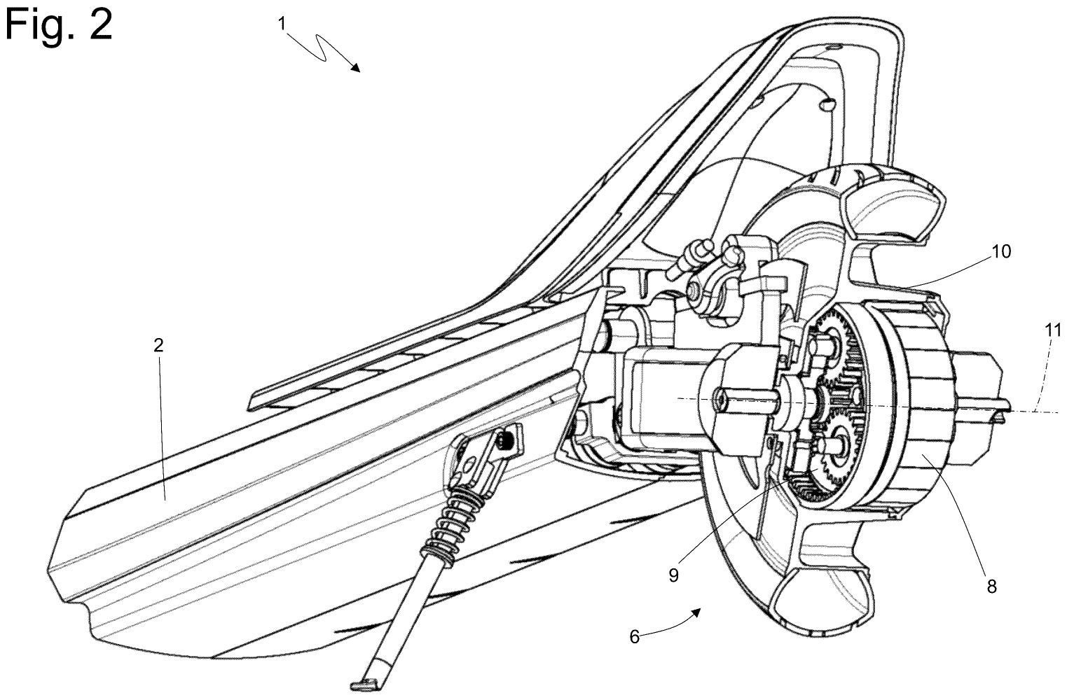

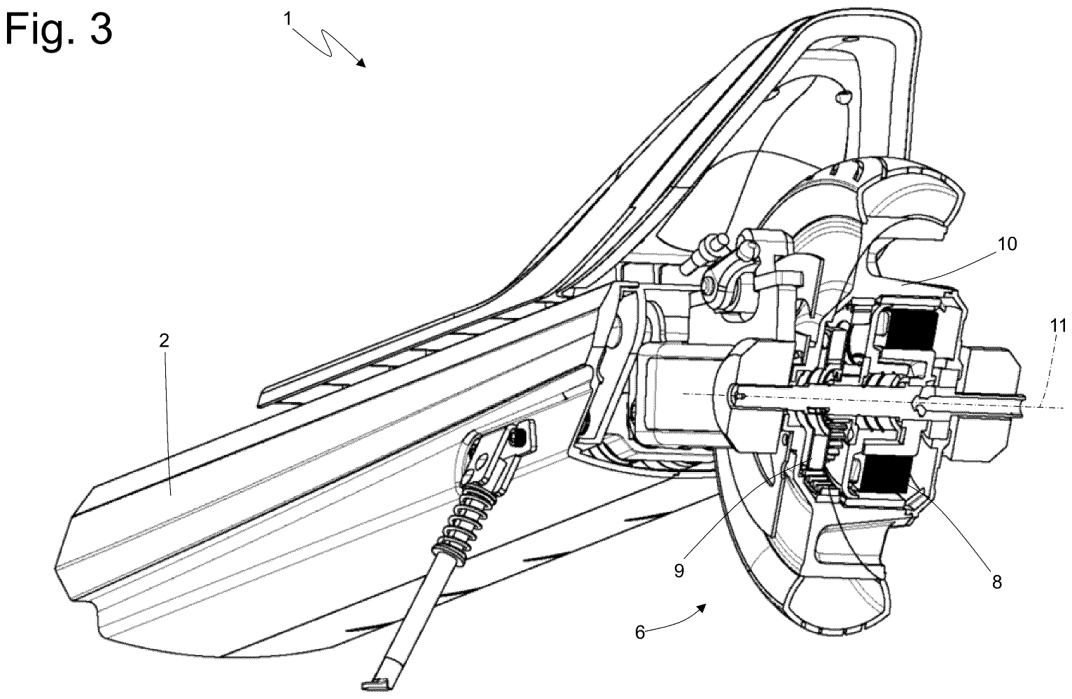

An alternative (second) embodiment is illustrated in FIGS. 2 and 3, in which the only modification relates to the driving wheel: in the electric scooter 1 illustrated in FIG. 1, the front wheel 5 is driving while the rear wheel 6 is driven (idle) whereas in the electric scooter 1 illustrated in FIGS. 2 and 3 the front wheel 5 is driven (idle) while the rear wheel 6 is driving. Consequently, in the electric scooter 1 illustrated in FIGS. 2 and 3, the electric motor 8 as well as the gearbox 9 are arranged within the enclosed container formed in the wheel rim 10 of the rear driving wheel 6. There are no further relevant differences between the electric scooter 1 illustrated in FIG. 1 and the electric scooter 1 illustrated in FIGS. 2 and 3.

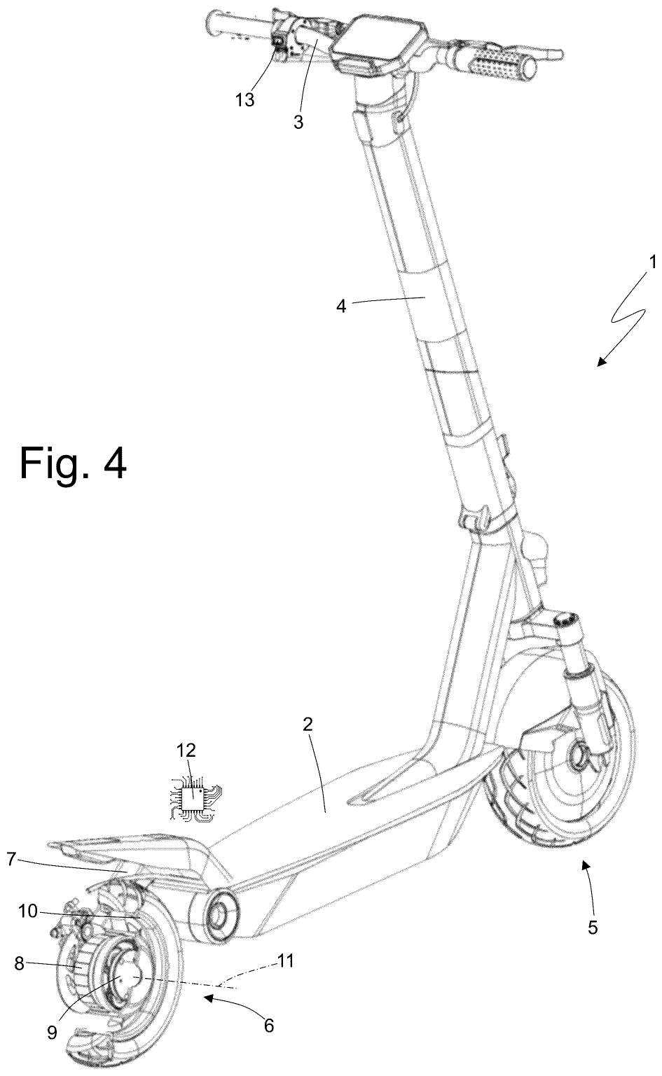

Also, in the embodiment illustrated in FIG. 4, the electric scooter 1 has the rear driving wheel 6, namely, the electric motor 8 and the gearbox 9 are arranged within the enclosed container formed in the wheel rim 10 of the rear driving wheel 6. In the embodiment illustrated in FIG. 4, the swingarm 7 is single-sided and allows coupling of the rear driving wheel 6, as well as reducing the weight of the electric scooter 1.

As illustrated in FIG. 4, a manual control 13 is provided, which is mounted on the handlebar 3 and is connected to the control device 12 to transmit, to the control device 12, the request to perform a gear change (namely, a change in the gear ratio) in the gearbox 9. Due to the manual control 13, the user of the electric scooter 1 can manually select the desired gear (gear ratio). The manual control 13 can comprise one or more buttons for forcing operation in low, or lower gear, or in high, or higher gear, in relation to the number of speed ratios with which the gearbox 9 is provided. Furthermore, the manual control 13 may comprise a button for choosing whether to activate a manual gear control (gear ratios) or whether to activate an automatic gear control (gear ratios).

In all the embodiments illustrated in FIGS. 1-4, the electric motor 8, the gearbox 9 and the driving wheel 5 or 6 (which can be either the front wheel 5 as illustrated in FIG. 1, or the rear wheel 6 as illustrated in FIGS. 2, 3 and 4) are all coaxial with one another, a shaft of the electric motor 8 is directly (namely, without any interposed element) connected to an input of the gearbox 9, and an output of the gearbox 9 is directly (namely, without any interposed element) connected to the driving wheel 5 or 6. Preferably, in all the embodiments illustrated in FIGS. 1-4, the driving wheel 5 or 6 (which can be either the front wheel 5 as illustrated in FIG. 1, or the rear wheel 6 as illustrated in FIGS. 2, 3 and 4) comprises a wheel rim 10 which defines an enclosed container, within which the electric motor 8 and the gearbox 9 are arranged side by side.

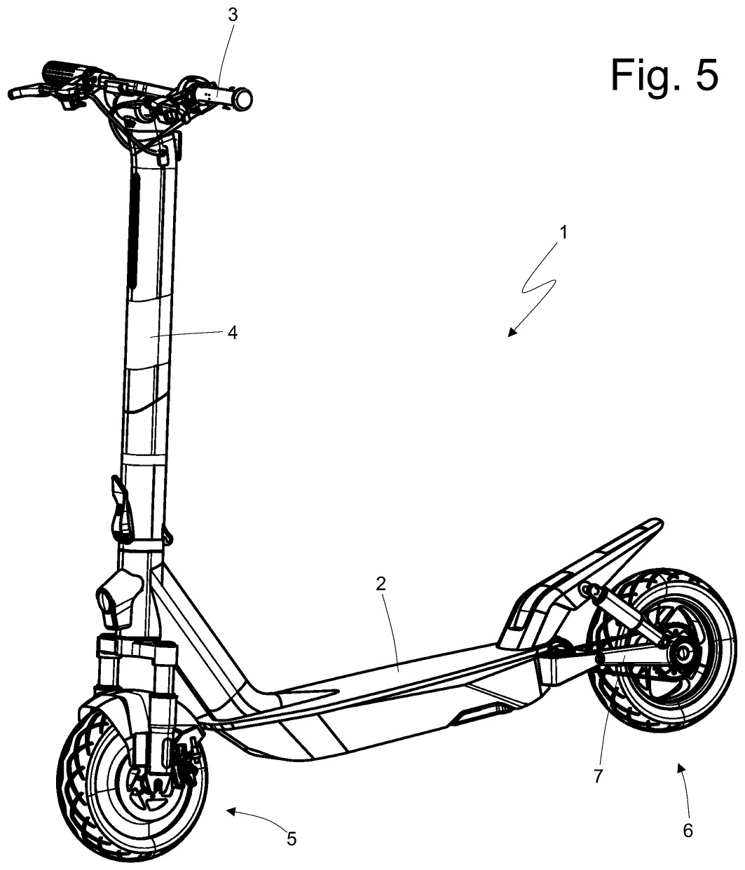

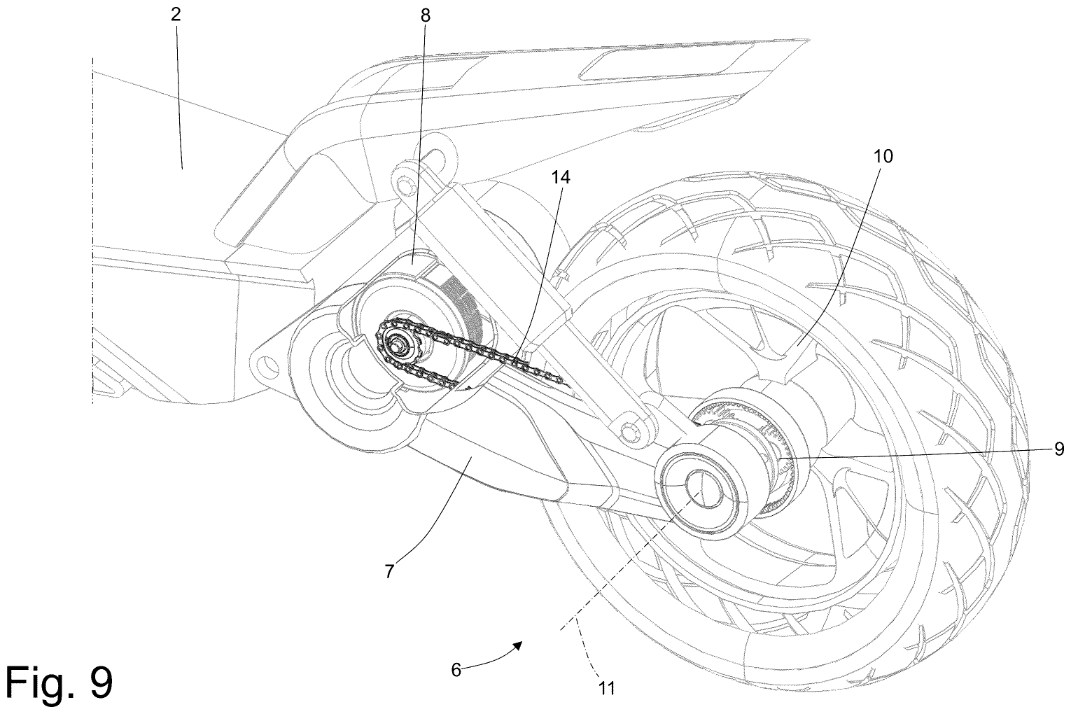

In the embodiments illustrated in FIGS. 5-11, the electric motor 8 is arranged at a longitudinal distance, namely, parallel to a direction of motion of the electric scooter 1 when in use, different from zero from the driving wheel 5 or 6 (which can be either the front wheel 5 or the rear wheel 6 as illustrated in FIGS. 5-11) so that the electric motor 8 is not coaxial with the driving wheel 5 or 6. Consequently, a flexible transmission member 14 closed in a loop is provided which transmits motion from the electric motor 8 to the driving wheel 5 or 6 (which can be both the front wheel 5 and the rear wheel 6 as illustrated in FIGS. 5-11); in the embodiment illustrated in FIGS. 5-11 the transmission member 14 is a chain, but alternatively the transmission member 14 could be a belt.

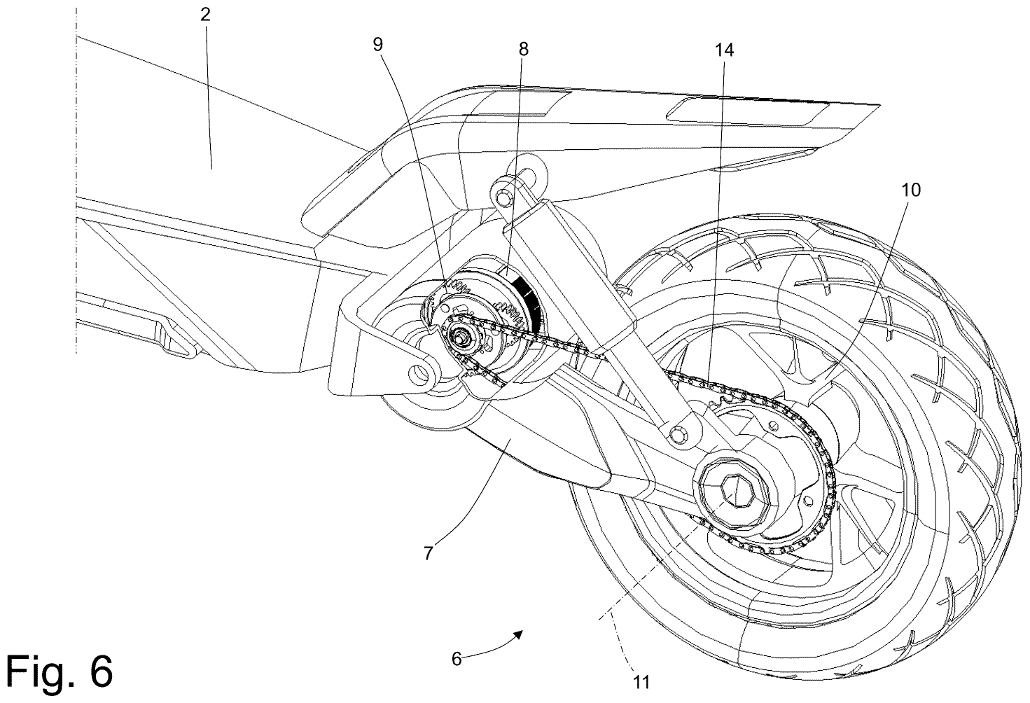

In the embodiments illustrated in FIGS. 6, 7 and 10, the electric motor 8 and the gearbox 9 are coaxial with one another, a shaft of the electric motor 8 is directly connected to an input of the gearbox 9, and an output of the gearbox 9 is connected to the rear driving wheel 6 by means of the flexible transmission member 14. In other words, the electric motor 8 and the gearbox 9 are coaxial with the same axis which is parallel and spaced from the rotation axis 11 of the rear driving wheel 6.

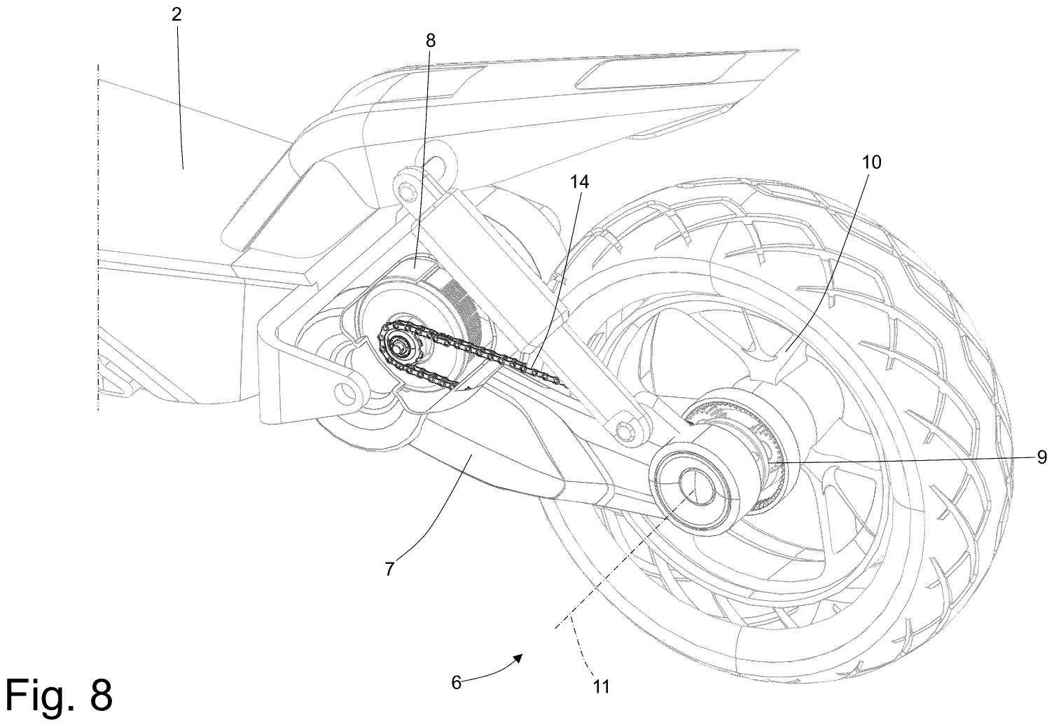

In the embodiments illustrated in FIGS. 8, 9 and 11, the gearbox 9 and the rear driving wheel 6 are coaxial with one another, a shaft of the electric motor 8 is connected to an input of the gearbox 9 by means of the flexible transmission member 14, and an output of the gearbox 9 is directly connected to the rear driving wheel 6.

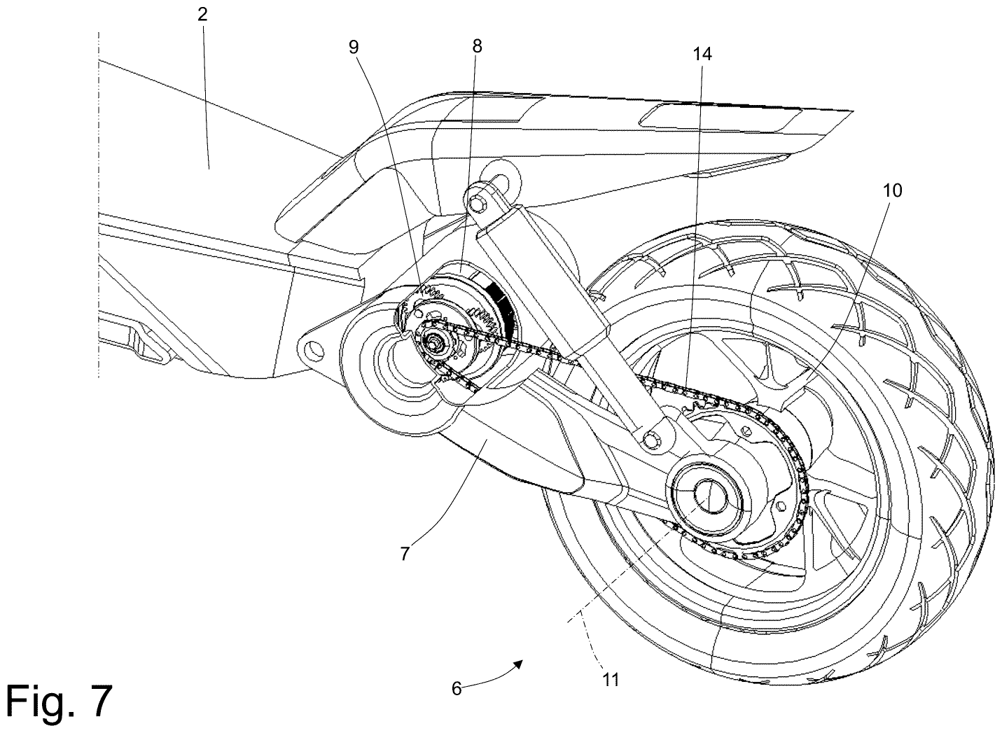

In the embodiments illustrated in FIGS. 6 and 8, the fulcrum of the swingarm 7 (namely, the hinge point of the swingarm 7 on the footboard 2) is coaxial with the electric motor 8; on the other hand, in the embodiments illustrated in FIGS. 7 and 9-11, the fulcrum of the swingarm 7 (namely, the hinge point of the swingarm 7 on the footboard 2) is arranged at a longitudinal distance, namely, parallel to a direction of motion of the electric scooter 1 when in use, different from zero from the electric motor 8 so that the fulcrum is not coaxial with the electric motor 8.

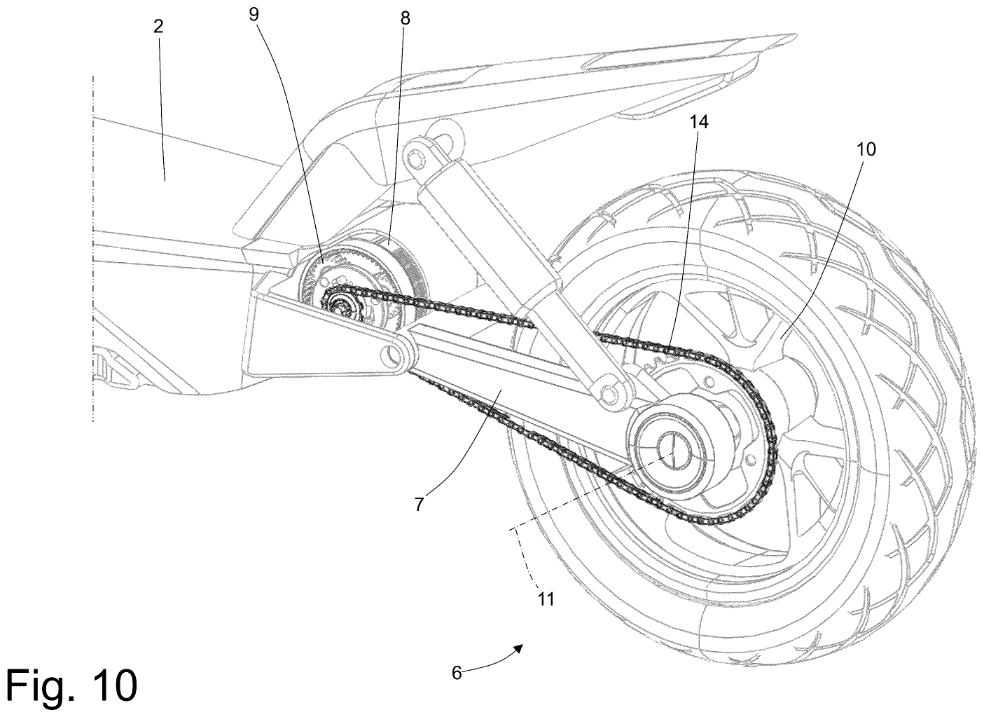

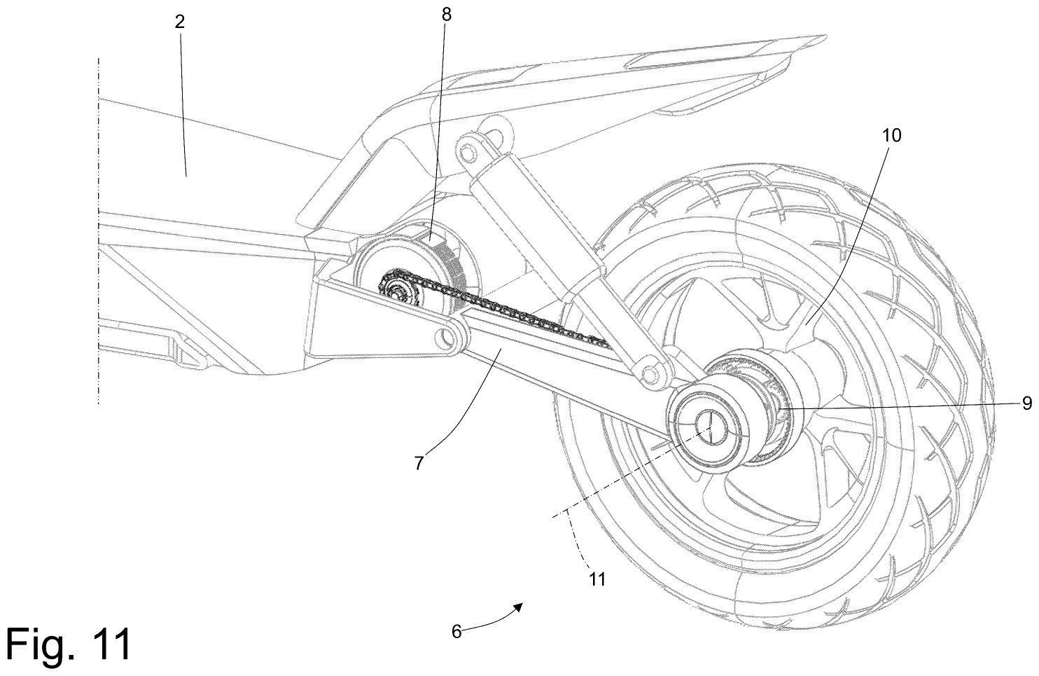

In the embodiments illustrated in FIGS. 6-9, the electric motor 8 is attached to the swingarm 7, namely, it is mounted on the swingarm 7 and therefore swings with respect to the footboard 2 together with the swingarm 7; instead, in the embodiments illustrated in FIGS. 10 and 11, the electric motor 8 is attached to the footboard 2, namely, the electric motor 8 is mounted on the footboard 2 and therefore is integral with the footboard 2 and does not swing together with the swingarm 7.

It is possible to provide alternatives of the electric scooter 1 which comprise a greater number of wheels, for example a three-wheeled electric scooter 1 could be provided (having a pair of front wheels 5 and a single rear wheel 6 or a single front wheel 5 and a pair of rear wheels 6) or a four-wheeled electric scooter 1 could be provided (having a pair of front wheels 5 and a pair of rear wheels 6).

The embodiments described herein can be combined with one another without departing from the scope of the present invention. Namely, numerous alternatives are possible, as well as combinations of the features disclosed for the various embodiments described above.

The electric scooter 1 described above has numerous advantages.

In particular, the electric scooter 1 described above has a high flexibility of use combined with a high level of autonomy.

Furthermore, the electric scooter 1 described above ensures a high degree of compactness and lightness, as well as a reduced production and maintenance costs.

### LIST OF REFERENCE NUMBERS OF THE FIGURES

1 electric scooter
2 footboard
3 handlebar
4 support
5 front wheel
6 rear wheel
7 swingarm
8 electric motor
9 gearbox
10 wheel rim
11 rotation axis
12 control device
13 manual control
14 gear member

1. An electric scooter comprising:
a footboard;
at least one driving wheel that is coupled to the footboard, is arranged in a front or rear position;
at least one driven wheel that is coupled to the footboard and is arranged in a rear or front position;
a handlebar operatively coupled to the footboard to turn a front wheel;
an electric motor that is suitable for turning the driving wheel; and
a gearbox with two or more gear ratios that is interposed between the electric motor and the driving wheel to receive motion from the electric motor and transmit motion to the driving wheel.

2. The electric scooter according to claim 1, wherein:
the electric motor is arranged at a longitudinal distance, i.e. parallel to a direction of motion of the electric scooter when in use, different from zero from the driving wheel so that the electric motor is not coaxial with the driving wheel; and
a flexible transmission member closed in a loop is provided, which transmits motion from the electric motor to the driving wheel.

3. The electric scooter according to claim 2, wherein the electric motor and the gearbox are coaxial with one another, a shaft of the electric motor is directly connected to an input of the gearbox, and an output of the gearbox is connected to the driving wheel by means of the flexible transmission member.

4. The electric scooter according to claim 2, wherein the gearbox and the driving wheel are coaxial with one another, a shaft of the electric motor is connected to an input of the gearbox via the flexible transmission member, and an output of the gearbox is directly connected to the driving wheel.

5. The electric scooter according to claim 1 and comprising a swingarm which at one end supports the driving wheel and at the opposite end is hinged to the footboard at a fulcrum coaxial with the electric motor.

6. The electric scooter according to claim 1 and comprising a swingarm which at one end supports the driving wheel and at the opposite end is hinged to the footboard at a fulcrum arranged at a longitudinal distance, i.e. parallel to a direction of motion of the electric scooter when in use, different from zero from the electric motor so that the fulcrum is not coaxial with the electric motor.

7. The electric scooter according to claim 1, wherein:
a swingarm is provided, which at one end supports the driving wheel and at the opposite end is hinged to the footboard at a fulcrum; and
the electric motor is attached to the footboard.

8. The electric scooter according to claim 1, wherein:
a swingarm is provided, which at one end supports the driving wheel and at the opposite end is hinged to the footboard at a fulcrum; and
the electric motor is attached to the swingarm.

9. The electric scooter according to claim 1, wherein the electric motor, the gearbox and the driving wheel are all coaxial with one another, a shaft of the electric motor is directly connected to an input of the gearbox, and an output of the gearbox is directly connected to the driving wheel.

10. The electric scooter according to claim 9, wherein the driving wheel comprises a rim defining an enclosed container, within which the electric motor and the gearbox are arranged side by side.

11. The electric scooter according to claim 1, wherein the gearbox comprises a control device configured to automatically select a gear ratio according to one or more parameters.

12. The electric scooter according to claim 11, wherein the control device is configured to arrange the gearbox in a shorter gear ratio at the start and to automatically select a gear ratio according to one or more of the parameters.

13. The electric scooter according to claim 11, wherein the parameters comprise: a number of revolutions of the electric motor, a value of a driving torque delivered by the electric motor, a value of an electric current drawn by the electric motor, positioning coordinates of the electric scooter, and a value provided by an inertial platform.

14. The electric scooter according to claim 11 and comprising a manual control operatively coupled to the control device and capable of allowing a user a manual selection of the gear ratio.

15. The electric scooter according to claim 1, wherein the gearbox is of the planetary type.

16. An electric scooter comprising:
a footboard;
at least one driving wheel that is coupled to the footboard, is arranged in a front or rear position;
at least one driven wheel that is coupled to the footboard and is arranged in a rear or front position;
a handlebar operatively coupled to the footboard to turn a front wheel;
an electric motor that is suitable for turning the driving wheel; and
a gearbox with two or more gear ratios that is interposed between the electric motor and the driving wheel to receive motion from the electric motor and transmit motion to the driving wheel;
wherein the electric motor is arranged at a longitudinal distance, i.e. parallel to a direction of motion of the electric scooter when in use, different from zero from the driving wheel so that the electric motor is not coaxial with the driving wheel; and
wherein a flexible transmission member closed in a loop is provided, which transmits motion from the electric motor to the driving wheel.

17. The electric scooter according to claim 16, wherein the electric motor and the gearbox are coaxial with one another, a shaft of the electric motor is directly connected to an input of the gearbox, and an output of the gearbox is connected to the driving wheel by means of the flexible transmission member.

18. The electric scooter according to claim 16, wherein the gearbox and the driving wheel are coaxial with one another, a shaft of the electric motor is connected to an input of the gearbox via the flexible transmission member, and an output of the gearbox is directly connected to the driving wheel.

19. An electric scooter comprising:
a footboard;
at least one driving wheel that is coupled to the footboard, is arranged in a front or rear position;
at least one driven wheel that is coupled to the footboard and is arranged in a rear or front position;
a handlebar operatively coupled to the footboard to turn a front wheel;
an electric motor that is suitable for turning the driving wheel; and
a gearbox with two or more gear ratios that is interposed between the electric motor and the driving wheel to receive motion from the electric motor and transmit motion to the driving wheel;
wherein the electric motor, the gearbox and the driving wheel are all coaxial with one another, a shaft of the electric motor is directly connected to an input of the gearbox, and an output of the gearbox is directly connected to the driving wheel.

20. The electric scooter according to claim 19, wherein the driving wheel comprises a rim defining an enclosed container, within which the electric motor and the gearbox are arranged side by side.
